(19) United States
(12) Patent Application Publication
(10) Pub. No.: US 2025/0243390 A1
(43) Pub. Date: Jul. 31, 2025

(54) HIGHLY THERMALLY INSULATING SEALING STRIP

(71) Applicant: Semperit AG Holding, Wien (AT)

(72) Inventors: Ralf Supplit, Wiener Neustadt (AT); Uwe Flockerzi, Rodalben (DE); Gerhard Schwaiberger, Offenberg (DE)

(21) Appl. No.: 18/854,314

(22) PCT Filed: Mar. 9, 2023
(86) PCT No.: PCT/EP2023/056043

§ 371 Date: Oct. 4, 2024

(30) Foreign Application Priority Data
Apr. 27, 2022 (DE) 10 2022 110 261.0
Aug. 2, 2022 (DE) 10 2022 119 349.7

(51) Int. Cl. C09J 109/00; E06B 7/23

(52) U.S. Cl. CPC C09J 109/00; E06B 7/2314

(57) ABSTRACT

A sealing strip for windows and doors comprises an elastomer composition) comprising 100 phr of elastomer and 20-45 phr of expanded microspheres, wherein the average diameter of the expanded microspheres is 10-200 μm and the elastomer composition has a density of 0.10-0.30 g/cm³.

### BACKGROUND

The present invention relates to a highly thermally insulating sealing strip made of an elastomer composition, a method for its manufacture and the use of the sealing strip for thermal insulation.

Sealing strips for the thermal insulation of windows and doors are already well known. To date, elastomer materials such as thermoplastic elastomers (TPE), silicone rubbers, ethylene propylene diene rubbers (EPDM), chloroprene rubber (CR) and polyvinyl chloride (PVC) have been used.

The heat transfer coefficient (U_{w} value) is decisive for the quality of thermal insulation. The heat transfer coefficient U_{w} is the amount of heat that passes through 1 m² of a building component (e.g. wall, concrete, roof) per unit of time (usually 1 second) at a temperature difference of 1 Kelvin (K). The U_{w} value is therefore a unit of measurement for heat loss. The lower the U_{w} value, the lower the heat loss and the better the thermal insulation properties of a building component. The lowest possible U_{w} value is therefore desirable for good thermal insulation and good insulating properties.

When calculating the U_{w} value for a window or door, it must be taken into account that the window or door consists of several components, in particular glazing and a frame.

The U_{w} value of the window or door is calculated from the respective U_{w} values of the individual components, taking into account the respective surface areas they occupy.

According to EnEV 2009, the U_{w} value for normal glazing must not exceed 1.3 watts per square meter and Kelvin (W/(m²·K)). Windows with a U_{w}-value of 0.9 W/(m²·K) are considered windows with efficient thermal insulation. Windows with a U_{w} value of 0.8 W/(m²·K) or less are considered suitable for passive houses.

In order to achieve good thermal insulation of a window or door using a highly thermally insulating sealing strip, the sealing strip should be made of a material with low thermal conductivity λ. The thermal conductivity λ corresponds to the heat flow that passes through an object with a surface area of 1 m² and a thickness of 1 m at a temperature difference of 1 K per second. According to DIN EN 10077, a thermal conductivity λ of =0.05 watts per meter and Kelvin (W/(m·K)) is currently assumed for U_{w} value calculations for sealing strips. However, this thermal conductivity of 0.05 W/(m·K) has so far only been achieved by materials with a density of 0.06-0.08 g/cm³. However, these materials have a low compression hardness of usually less than 300 kPa at 50% compression, which limits their use in the construction sector. The commercially available building materials for sealing strips have a higher density and higher thermal conductivity. For example, the thermal conductivity of PVC is 0.14-0.17 W/(m·K) at a density of around 1.20-1.40 g/cm³ and of silicones around 0.2-0.3 W/(m·K) at a density of around 0.76-1.07 g/cm³ or 0.05 W/(m·K) at a density of 0.2 g/cm³.

The use of hollow microspheres to reduce the density of materials for seals is known from the prior art. From US 2013/0072584 A1, sealing strips for motor vehicles are known, comprising a main body element made of a high-density material and a sponge body made of a compressible material, wherein the sponge body contains rubber and expandable microspheres as a physical expanding agent.

However, to date there is no known sealing strip made of a material that achieves the thermal conductivity λ=0.05 W/(m·K) assumed in DIN EN 10077 and at the same time has elastic behavior and high rigidity with low density.

It is therefore the task of the present invention to provide a sealing strip with improved thermal insulation properties, in particular with a thermal conductivity λ<0.060 W/(m·K), which is suitable for a permanent function and has high elasticity, good resilience and high rigidity with low density.

### SUMMARY OF THE INVENTION

A sealing strip according to the invention, in particular for windows and doors, comprises an elastomer composition containing
100 phr elastomer and
20-45 phr expanded microspheres,
where the average diameter of the expanded microspheres is 10-200 μm and the elastomer composition has a density of 0.10-0.30 g/cm³.

The high proportion of 20-45 phr expanded microspheres with an average diameter of the expanded microspheres of 10-200 μm ensures a low density and low thermal conductivity of the elastomer composition and, surprisingly, at the same time a high rigidity of the material as well as a high elasticity and good resilience of the material. This was previously unattainable, especially with chemical blowing agents.

A method of manufacturing a sealing strip comprises the steps of heating a material mixture comprising 100 phr of elastomer and 20-45 phr of expandable microspheres to a temperature of 75-300° C. and forming a sealing strip. During heating, the expandable microspheres expand and form expanded microspheres. The “material mixture” refers to the starting material that is heated and contains expandable microspheres, and the “elastomer composition” refers to the material obtained after heating that contains expanded microspheres.

In particular, the sealing strip for windows and doors can be a sealing strip for building windows, building doors and building gates, i.e. designed as a building (window/door/gate) sealing strip.

Further advantages and features can be seen from the respective sub-claims, as well as from the description and the figures.

According to the invention, the sealing strip comprises an elastomer to achieve high elasticity and expanded microspheres, which enable high rigidity and low density, as well as low thermal conductivity.

A seal can be an element or structure designed to prevent or limit the unwanted transfer of material or heat from one location to another.

The sealing strip can be a seal in the form of a profile body that extends in a longitudinal direction or profile direction and whose cross-section has a certain geometric shape. Preferably, the geometric shape of the cross-section does not change over the longitudinal direction or profile direction, so that the cross-sectional surfaces of the profile body are congruent in the longitudinal direction at every position.

The sealing strip can be designed as a center seal, side seal and/or as an insulating strip.

The sealing strip can be produced by extrusion, calendering or pressing. Extrusion is a process in which a plastically deformable, viscous material is continuously pressed out of a shaping opening under pressure. The shaping opening can be a die, a nozzle or a mouthpiece. The molded mass can harden by cooling after leaving the shaping opening. The advantage of extrusion is that it can be used to produce profiles with complex cross-sectional shapes in almost any length. Calendering is a process in which a material is passed through a system of several rollers arranged one above the other. Pressing is a process in which a material is introduced between two solid bodies, preferably plates, and the two solid bodies are moved towards each other so that a force is exerted on the material between the two solid bodies.

According to a further aspect of the invention, the elastomer composition from which the sealing strip is formed has a density of 0.10-0.30 g/cm³, preferably of 0.12-0.28 g/cm³ and most preferably of 0.17-0.26 g/cm³. With these densities, particularly low thermal conductivities of the material can be achieved.

The elastomer composition according to the invention comprises 20-45 phr, preferably 22-40 phr, more preferably 25-38 phr of expanded microspheres. With these proportions of expanded microspheres, it is surprisingly possible to achieve a particularly low thermal conductivity of the elastomer composition with simultaneously high rigidity of the material, high elasticity and good resilience of the material.

In a preferred embodiment of the invention, the elastomer composition additionally comprises
10-150 phr plasticizer
20-400 phr filler
0-100 phr chemical blowing agent
1-50 phr excipient and
0-30 phr drying agent and optional
1-30 phr, preferably 3-12 phr, particularly preferably 5-10 phr crosslinker.

According to the invention, the material mixture for producing the sealing strip according to the invention comprises an elastomer composition:
100 phr elastomer
0-300 phr, preferably 10-150 phr, particularly preferably 20-100 phr, plasticizer
0-600 phr, preferably 20-400 phr, particularly preferably 50-180 phr, filler
0-30 phr, preferably 1-30 phr, further preferably 3-12 phr, particularly preferably 5-10 phr, crosslinker
20-45 phr, preferably 22-40 phr, further preferably 25-38 phr expandable microspheres
0-100 phr, preferably 1-15 phr, particularly preferably 5-10 phr, chemical blowing agent
0-100 phr, preferably 1-50 phr, particularly preferably 1-10 phr, excipient
0-30 phr, preferably 1-20 phr, particularly preferably 2-10 phr, drying agent.

The sealing strip according to the invention is produced from an elastomer composition by heating the material mixture to a temperature of 75-300° C., preferably 200-280° C., more preferably 210-270° C. and forming a sealing strip, for example by extrusion, calendering or pressing. During heating, the expandable microspheres expand to form expanded microspheres. If crosslinker is contained in the material mixture, crosslinking of the elastomer can also take place.

According to the invention, the sealing strip, in particular for windows and doors, is made of an elastomer composition comprising:
100 phr elastomer
0-300 phr, preferably 10-150 phr, particularly preferably 20-100 phr, plasticizer
0-600 phr, preferably 20-400 phr, particularly preferably 50-180 phr, filler
20-45 phr, preferably 22-40 phr, further preferably 25-38 phr expanded microspheres
0-100 phr, preferably 1-15 phr, particularly preferably 5-10 phr, chemical blowing agent
0-100 phr, preferably 1-50 phr, particularly preferably 1-10 phr, excipient
0-30 phr, preferably 1-20 phr, particularly preferably 2-10 phr, drying agent.

Preferably, the elastomer composition contains 1-30 phr, further preferably 3-12 phr, particularly preferably 5-10 phr, of crosslinker.

As usual, phr (parts per hundred rubber) refers to the mass proportion of the individual components of an elastomer composition, wherein the figures are based on 100 parts by mass of the elastomer.

The specification phr can also be converted into percent by weight in a manner known to the skilled person. For this purpose, the masses of the individual components are divided by the total mass of the composition. For example, a composition with 100 phr elastomer, 10 phr plasticizer and 10 phr expandable microspheres would correspond to a composition with 83.3% by weight elastomer, 8.3% by weight plasticizer and 8.3% by weight expandable microspheres.

The elastomer can be an elastomer or an elastomer blend (elastomer mixture). Preferably, the elastomer in this material mixture or elastomer composition is EPM (ethylenepropylene copolymer), EPDM (ethylene-propylene-diene rubber) or blends (mixtures) of EPDM and BR (butadiene-rubber, i.e. polybutadiene). The elastomer gives the sealing strip high elasticity and high weather resistance.

In a preferred embodiment, the material mixture for producing the sealing strip also comprises crosslinker, for example 1-30 phr crosslinker, in addition to the elastomer. The crosslinker reacts with the elastomer during heating/vulcanization and thus forms an elastomer that is more strongly crosslinked. The crosslinker is incorporated into the elastomer and thus forms part of the elastomer of the elastomer composition that forms the sealing strip. Therefore, the crosslinker is not listed as a separate component in the elastomer composition according to the invention.

If the elastomer and the crosslinker are also considered as separate components in reacted form, the sealing strip according to the invention would be composed as follows. A sealing strip, in particular for windows and doors, preferably of an elastomer composition comprising:
100 phr elastomer,
20-45 phr expanded microspheres, and
1-30 phr, preferably 3-12 phr, particularly preferably 5-10 phr, of a crosslinker,
wherein the average diameter of the expanded microspheres is 10-200 μm and the elastomer composition has a density of 0.10-0.30 g/cm³.

The plasticizer may comprise an oil, in particular a mineral oil, a vegetable oil and/or a polymer. The polymer may comprise a polyisobutylene. The plasticizer makes it possible to optimize the viscosity of the elastomer composition and to adjust the hardness of the sealing strip. Several different plasticizers can be used in an elastomer composition.

The filler can be a substance that can be added to the elastomer composition to optimize its properties. For example, carbon black, kaolin, chalk or silica can be used as a filler. Polymeric fillers can also be used. Polymeric fillers may include polypropylene and/or polyethylene. Aluminum hydroxide, magnesium hydroxide and/or antimony trioxide can be used as flame-retardant fillers. Furthermore, lightweight fillers comprising porous materials such as perlite can be used. For example, Aeropor 180 (hollow spheres based on aluminum silicate), Silcel (expanded perlite) and/or Cenospheres (hollow spheres based on aluminum silicate) and/or lightweight spheres (“light bubbles”, e.g. borosilicate glass spheres) can be used. Several fillers can be used in one material mixture or elastomer composition. Fillers have the advantage of increasing the extrudability of the material mixture or elastomer composition. Furthermore, fillers can improve the mechanical properties of the sealing strip. In particular, fillers can increase the rigidity of the sealing strip and maintain or reduce the thermal conductivity.

The crosslinker can be a substance or a mixture of substances that causes complete or partial crosslinking of the polymer chains of the elastomer or elastomer section. In particular, the crosslinker can be a crosslinking system comprising sulphur and/or peroxide, accelerators and/or activators, and/or a resin system. A peroxide can preferably be an organic peroxide compound or a mixture of organic peroxide compounds. Peroxides have the advantage of increasing the degree of cross-linking of the polymer chains and the rigidity of the sealing strip. The activator can be a substance that activates the polymer chains to be crosslinked and/or the crosslinker. The activator can be stearic acid or zinc oxide. The activator has the advantage of enabling efficient cross-linking of polymer chains. The accelerator can be one or a mixture of several substances that increase the crosslinking rate (speed of crosslinking). The accelerator can be 2-mercaptobenzothiazole (MBT) and/or tetramethylthiuram disulfide (TMTD). The accelerator has the advantage of increasing the degree of cross-linking of the polymer chains and increasing the rigidity of the sealing strip. Several different crosslinkers, crosslinking systems, activators and/or accelerators can be used in a material mixture. Crosslinkers, crosslinking systems, activators and/or accelerators have the advantage of increasing the rigidity of the sealing strip. By selecting an optimum ratio of crosslinker, crosslinking system, activators and/or accelerators, an optimum degree of crosslinking of the polymer chains, high rigidity and high elasticity of the sealing strip and optimum blowing behavior of the chemical and physical blowing agents can be achieved.

In the context of the invention, expandable microspheres are understood to be microscopic spheres, i.e. essentially spherical bodies with an average diameter in the micrometer range, in particular with an average diameter of 1-100 μm, preferably 5-50 μm, particularly preferably 6-40 μm, which have a shell of thermoplastic material and have a volatile organic compound within the shell which can act as a blowing agent.

The volatile organic compound is preferably an organic compound, preferably a hydrocarbon, with a boiling point <120° C., more preferably <100° C., even more preferably <60° C., most preferably <40° C. The boiling point is preferably below the so-called bowing temperature. The blowing temperature is a temperature that is high enough to soften the thermoplastic shell and increase the vapor pressure of the blowing agent so that the microspheres expand. The expansion leads to an increase in volume by at least a factor of two, preferably by a factor of twenty to eighty.

After expansion, the expandable microspheres are referred to as expanded microspheres. The material mixture therefore contains expandable microspheres and the elastomer composition produced therefrom contains expanded microspheres. Expanded microspheres are thus preferably understood in the sense of the invention to mean microspheres with a shell, preferably a closed shell, made of thermoplastic material, wherein an organic compound is present in the interior of the shell. The organic compound preferably has a boiling point <120° C., more preferably <100° C., even more preferably <60° C., most preferably <40° C. The organic compound is preferably a hydrocarbon, for example isopentane.

The thermoplastic material, in particular a thermoplastic resin, is preferably a polymer based on polyacrylonitrile, polystyrene and/or PVC. The expandable microspheres preferably have a blowing temperature of 25° C. to 300° C., preferably from 100° C. to 290° C., most preferably 200° C. to 280° C. Expandable microspheres with a blowing temperature of 25° C. to 300° C. allow the microspheres to expand when the material mixture is heated. The volatile hydrocarbon compounds act as a blowing agent and cause a particularly effective expansion of the hollow microspheres.

The thermoplastic shell can soften when exposed to heat. When the boiling point of the hydrocarbon compound is reached, vaporization takes place, whereby the volume occupied by the hydrocarbon compound increases and causes the microspheres to expand. The average diameter of the expandable microspheres is 1-100 μm, preferably 5-50 μm, particularly preferably 6-40 μm. After exposure to heat and expansion of the expandable microsphere, an expanded microsphere or hollow microsphere is present. The expanded microspheres or hollow microspheres have an average diameter of 10-200 μm, preferably 30-170 μm, more preferably 40-150 μm, most preferably 50-130 μm.

The average diameter of the expanded microspheres is determined by measuring the diameter of at least 20 expanded microspheres in a section through the elastomer composition under a microscope (e.g. an optical microscope) and determining the arithmetic mean value. In the case of microspheres that are not completely spherical, a diameter is selected at random. In this measurement of the diameters of the expanded microspheres in a section through the elastomer composition, the actual diameters are not determined, but rather the diameters in a (random) section, and these diameters are smaller than the actual diameters because a random section predominantly does not pass through the center of the spheres. However, the mean diameters determined in a section using the measurement method described above result in the specified ranges of the mean diameters of the expanded microspheres.

The average diameter of the expandable microspheres, i.e. the microspheres before the expansion step, is usually specified for commercially available products. It can be determined by measuring the diameter of at least 20 expandable microspheres, for example under a microscope, and determining the arithmetic mean.

The average thickness of the shell of the expandable microspheres is preferably 1-3 μm, particularly preferably 1.5-2.5 μm. The average thickness of the shell of the expanded microspheres is preferably 0.02-0.5 μm, particularly preferably 0.05-0.3 μm, most preferably 0.08-0.2 μm.

The expanded microspheres or hollow microspheres have the advantage that in the elastomer composition according to the invention, which forms the sealing strip, a low density of the elastomer composition or the material of the sealing strip can be achieved and at the same time a high rigidity of the material is still present.

Expancel® microspheres, for example Expancel 930 DU 120, can be used as expandable microspheres. The expandable microspheres can have a polymer shell comprising PAN (polyacrylonitrile). For example, the polymer shell can consist of polystyrene and PAN (as a copolymer). The blowing temperature depends on the softening temperature of the polymer shell. Isopentane (boiling point 28° C.) can be used as an organic solvent for Expancel® microspheres. Expancel® microspheres usually have a diameter of around 120 μm when expanded. The expandable microspheres serve as a physical expanding agent, which is used to form pores and reduce the density. The size of the resulting pores corresponds approximately to the size of the expanded microspheres, which is why the pore diameter is ≤200 μm, preferably <150 μm and more preferably <130 μm, in particular the average diameter of the pores is 10-200 μm, preferably 30-170 μm, more preferably 40-150 μm, most preferably 50-130 μm.

The additional advantage of expanded microspheres or physical expanding agents is that smaller pore diameters and therefore a finer pore structure can be achieved than with chemical blowing agents. Furthermore, the pore size can be easily and precisely adjusted by using expandable microspheres. Surprisingly, the advantage of the expandable microspheres is that a higher rigidity of the sealing strip could be achieved with the same density than with chemical blowing agents and a thermal conductivity of the elastomer composition of the sealing strip of A <0.060 W/(m·K) could be achieved.

A chemical blowing agent can be used in addition to the microspheres. A chemical blowing agent can be a substance that decomposes at a certain temperature, releasing a gas such as carbon dioxide. For example, isocyanate, water, azodicarbonamide, hydrazine, in particular ptoluenesulfonyl hydrazide (TSH), and/or 4,41-oxydi (benzenesulfonohydrazide) (OBSH) and/or sodium bicarbonate can be used as chemical blowing agents. The material mixture according to the invention may contain no chemical blowing agent, a chemical blowing agent or a mixture of different chemical blowing agents. The advantage of the chemical blowing agent(s) is the reduction in the density of the sealing strip due to pore formation.

The additive can be an anti-ageing agent, a vulcanization retarder, a resin and/or a processing aid. The additive can be added to the material mixture to optimize the processing properties and surface finish of the sealing strip. The processing aid can be petroleum jelly, factice (=artificial rubber, oil rubber), kerosene wax, zinc salt, a fatty acid, a fatty alcohol, a fatty acid ester, fatty acid amide, polyolefin wax and/or stearic acid. Several different processing aids can be used in a material mixture. The advantage of the processing aid is the simple, cost-effective processing of the material mixture and the avoidance of defects, such as undesirable gas inclusions in the sealing strip, which can reduce the rigidity and/or elasticity of the sealing strip.

The drying agent can be a substance that is suitable for absorbing moisture. Calcium chloride (CaCl₂)), anhydrous magnesium sulphate (MgSO₄), anhydrous calcium sulphate (CaSO₄), silica gel, zeolites and preferably calcium oxide (CaO) can be used as drying agents. Several different drying agents can be used in the material mixture. The drying agent has the advantage of reducing unwanted moisture in the material mixture and increasing the service life of the sealing strip.

According to one embodiment, the material mixture is heated to a temperature of 75-300° C., preferably 200-280° C., more preferably 210-270° C. At a temperature of 75-300° C., vulcanization of the material mixture and expansion of the microspheres can take place. The advantage of the temperature range of 75-300° C. is that the process can be carried out easily without strict temperature control. The advantage of the temperature range of 200-280° C. is the controlled expansion of the microspheres and the improved rigidity of the sealing strip. The temperature range of 210-270° C. enables uniform and controlled expansion of the microspheres and optimum rigidity of the sealing strip and low thermal conductivity of the sealing strip.

According to a further embodiment, the material mixture can be extruded, calendered and/or pressed. The material mixture can be formed by extrusion, calendering or pressing. It is particularly preferred that the material mixture is formed by extrusion. The advantage of the extrudable, calenderable and/or pressable material mixture is that processing, in particular shaping, of the material mixture is possible despite the high rigidity of the sealing strip. The material mixture can be shaped on a large scale using industrial methods.

According to one embodiment, the extrusion, calendering or pressing of the material mixture takes place during heating, preferably during vulcanization.

According to one aspect of the invention, the elastomer composition from which the sealing strip is formed has a thermal conductivity λ<0.060 W/(m·K), more preferably λ<0.057 W/(m·K), even more preferably <0.050 W/(m·K) and most preferably <0.045 W/(m·K).

The sealing strip comprises the elastomer composition according to the invention. The sealing strip can be manufactured entirely or partially from the elastomer composition. The elastomer composition can be produced by processing the material mixture according to the invention. In particular, the elastomer composition according to the invention can be produced by vulcanization of the material mixture. Furthermore, the elastomer composition according to the invention can be produced by extrusion and/or calendering of the material mixture.

The sealing strip may consist entirely (100%) or in part (e.g. 10%, 50% or 80%) of the elastomer composition according to the invention.

According to a further embodiment, the elastomer composition according to the invention, of which the sealing strip consists at least in part, has a high compression hardness. The compression hardness of the elastomer composition according to the invention can be measured when a test specimen is compressed. For example, the compression hardness can be measured at a compression of 25%. This means that the height of a test specimen during the application of force is 25% lower than before the application of force. The force or pressure can be specified in kilo-Pascals (kPa). The test specimen can be a square test specimen. The test specimen can consist of or comprise the material mixture according to the invention. The compression hardness can be determined according to ISO 3386 by compressing the test specimen between two plates by a certain percentage and measuring the force required for this. The elastomer composition according to the invention preferably has a compression hardness of at least 100 kPa, preferably at least 300 kPa, more preferably at least 500 kPa, at a compression of 25%, of at least 200 kPa, preferably at least 500 kPa, more preferably at least 800 kPa, at a compression of 40% and/or of at least 300 kPa, more preferably at least 800 kPa and most preferably at least 1000 kPa, at a compression of 50%.

According to a further embodiment, the elastomer composition according to the invention, of which the sealing strip consists in whole or in part, has an optimum compression set. According to this embodiment, the elastomer composition according to the invention has a compression set of less than or equal to 70%, more preferably less than or equal to 60%, most preferably less than or equal to 55% at a compression of 25% for 24 hours at 70° C. and/or a compression set of less than or equal to 50%, more preferably less than or equal to 40%, most preferably less than or equal to 30% at a compression of 25% for 24 hours at 23° C. and/or a compression set of less than or equal to 80%, preferably less than or equal to 70%, most preferably less than or equal to 60% at a compression of 25% for 24 hours at −10° C. Compression set (DVR) is a measure of how an elastomer behaves during prolonged, constant compression set and subsequent relaxation. According to DIN 53 517 or DIN ISO 8 15 or ASTM D 395, the compression set is measured at constant deformation. To determine the compression set, a test specimen is compressed by 25% and stored at a certain temperature for a certain period of time (e.g. 24 hours). A certain time after the load has been removed, e.g. 30 minutes after the load has been removed, the height of the test specimen is measured at room temperature and the permanent deformation is determined from the difference between the height of the test specimen before the application of the force and the height of the test specimen after the application of the force.

According to a further embodiment, the material mixture according to the invention and the elastomer composition according to the invention contain 20-100 phr of plasticizer. The advantage of the elastomer composition with 20-100 phr plasticizer is the improved processability of the elastomer composition and a high elasticity of the sealing strip.

According to a further embodiment, the elastomer composition according to the invention contains 50-180 phr of filler. The advantage of the elastomer composition with 50-180 phr filler is the optimum rigidity of the sealing strip and the low thermal conductivity.

According to a further embodiment, the elastomer composition according to the invention contains 5-10 phr of crosslinker. The advantage of the elastomer composition with 5-10 phr crosslinker is an optimum degree of crosslinking, which simultaneously enables high elasticity and high rigidity of the sealing strip as well as the long service life of the sealing strip.

According to a further embodiment, the material mixture according to the invention comprises 20-45 phr, preferably 22-40 phr, more preferably 25-38 phr of expandable microspheres. The elastomer composition obtainable from the material therefore comprises 20-45 phr, preferably 22-40 phr, more preferably 25-38 phr of expanded microspheres.

The advantage of the elastomer composition with the aforementioned quantities of expanded microspheres is the reduced thermal conductivity of the sealing strip compared to sealing strips with a lower proportion of hollow microspheres and the increased rigidity of the sealing strip.

According to a further embodiment, the material mixture according to the invention contains 1-15 phr, more preferably 5-10 phr of chemical blowing agent. The advantage of the material mixture with 1-15 phr of the chemical blowing agent is the low density of the sealing strip. The advantage of the material mixture with 5-10 phr of the chemical blowing agent is the low density of the sealing strip and the improved thermal insulation properties.

In the material mixture according to the invention, the chemical blowing agent and a physical blowing agent, in particular the expandable microspheres, can be used. The combination of the chemical blowing agent and the expandable microspheres has the advantage that the processing behavior of the material mixture and the elastomer composition obtained therefrom can be improved, in particular during extrusion. Furthermore, the use of the chemical blowing agent in combination with the expandable microspheres has the advantage that a smaller amount of expandable microspheres in the material mixture is sufficient to achieve a low density of the sealing strip. Furthermore, the combination of the chemical blowing agent and the expandable hollow microspheres has the advantage that the resulting elastomer composition has a high compression hardness.

According to a further embodiment, the material mixture according to the invention and the elastomer composition obtainable therefrom contain 1-10 phr of auxiliary material or processing aid. The advantage of the material mixture and the elastomer composition obtainable therefrom with 1-10 phr auxiliary material or processing aid is the optimization of the processability of the material mixture and the elastomer composition obtainable therefrom, and the high rigidity in combination with a high elasticity of the sealing strip.

According to a further embodiment, the material mixture according to the invention and the elastomer composition obtainable therefrom contains 1-20 phr, preferably 2-10 phr of drying agent. The advantage of the material mixture and the elastomer composition obtainable therefrom with 1-20 phr drying agent is the increased service life of the sealing strip. The advantage of the material mixture and the elastomer composition obtainable therefrom with 2-10 phr drying agent is the improved processability of the material mixture and the elastomer composition obtainable therefrom, the improved thermal insulation properties, the avoidance of uncontrolled porosity due to moisture in the material mixture, and the increased service life of the sealing strip.

The advantages of the sealing strip according to the invention are its high rigidity, low density, low thermal conductivity, good thermal insulation properties and long service life. The elasticity and the recovery behavior of the sealing strip according to the invention are improved compared to conventional sponge rubber or conventional sponge rubber mixtures. The sealing strip according to the invention can be used as a pure insulating material, as a center seal, as a side seal and/or as an insulating strip, in particular for windows and doors.

In the context of the invention, sponge rubber or conventional sponge rubber refers to a predominantly closed-pore, elastic foam material that does not contain any expanded microspheres. Sponge rubber in this sense is usually produced with chemical blowing agents.

The invention also relates to a method of manufacturing a sealing strip according to the invention, comprising the following steps:
Step S1: Providing the following components:
   100 phr elastomer
   0-300 phr, preferably 10-150 phr, particularly preferably 20-100 phr, plasticizer
   0-600 phr, preferably 20-400 phr, particularly preferably 50-180 phr, filler
   0-30 phr, preferably 1-30 phr, further preferably 3-12 phr, particularly preferably 5-10 phr, crosslinker
   20-45 phr, preferably 22-40 phr, further preferably 25-38 phr expandable microspheres
   0-100 phr, preferably 1-15, particularly preferably 5-10 phr, chemical blowing agent
   0-100 phr, preferably 1-50 phr, particularly preferably 1-10 phr, auxiliary material
   0-30 phr, preferably 1-20 phr, particularly preferably 2-10 phr, drying agent;
Step S2: Mixing the components, in particular in a mixer or a blender, to obtain a material mixture according to the invention;
Step S3: Forming the material mixture according to the invention into a sealing strip, in particular by extrusion, calendering or pressing.
Step S4: Heating the material mixture according to the invention to a temperature, preferably a vulcanization temperature, of 75-300° C., preferably 200-280° C., particularly preferably 210-270° C., in order to form a sealing strip according to the invention from an elastomer composition.

According to one embodiment, the extrusion, calendering or pressing takes place during the heating, preferably the vulcanization, of the material mixture according to the invention. Steps S3 and S4 can thus be carried out simultaneously or consecutively. Forming the material mixture by means of extrusion, calendering or pressing during heating, preferably vulcanization, has the advantage of cost-effective and energy-efficient process control.

According to one embodiment, heating, preferably vulcanization, takes place continuously directly after shaping by extrusion. The heating, preferably the vulcanization, can be carried out by UHF (ultra-high frequency) and/or hot air, by heat transfer by means of steam or a liquid vulcanization medium, such as potassium nitrite and/or potassium nitrate salt.

All advantages and features of the sealing strip according to the invention can be transferred analogously to the method, and vice versa. Individual features and embodiments mentioned above can be combined with each other and the advantages assigned to the individual features also apply to a combination of these features. The mixing of the components, the heating of the material mixture and the molding of the material mixture can be carried out using prior art devices and methods.

The invention also relates to a sealing strip obtainable by the method according to the invention, comprising the steps of heating a material mixture comprising 100 phr of elastomer and 20-45 phr of expandable microspheres to a temperature of 75-300° C. and forming a sealing strip.

The material mixture for producing the sealing strip according to the invention, obtainable by the method according to the invention, preferably comprises:
100 phr elastomer
0-300 phr, preferably 10-150 phr, particularly preferably 20-100 phr, plasticizer
0-600 phr, preferably 20-400 phr, particularly preferably 50-180 phr, filler
0-30 phr, preferably 1-30 phr, further preferably 3-12 phr, particularly preferably 5-10 phr, crosslinker
20-45 phr, preferably 22-40 phr, further preferably 25-38 phr expandable microspheres
0-100 phr, preferably 1-15 phr, particularly preferably 5-10 phr, chemical blowing agent
0-100 phr, preferably 1-50 phr, particularly preferably 1-10 phr, auxiliary material
0-30 phr, preferably 1-20 phr, particularly preferably 2-10 phr, drying agent.

The sealing strip, obtainable by the method according to the invention, is produced by heating the material mixture to a temperature of 75-300° C., preferably 200-280° C., more preferably 210-270° C. and forming the sealing strip, for example by extrusion, calendering or pressing. During heating, the expandable microspheres expand to form expanded microspheres. If crosslinker is contained in the material mixture, crosslinking of the elastomer can also take place.

The invention is also directed to a geometry for a sealing strip made of the elastomer composition according to the invention. The geometry can be the three-dimensional shape of the sealing strip or a two-dimensional cross-section perpendicular to the longitudinal direction. In the following, the geometry according to the invention is described with reference to the two-dimensional cross-section perpendicular to the longitudinal direction of the sealing strip.

The sealing strip according to the invention comprises a head area and a foot area. The head area can be the upper half of the sealing strip. The foot area can be the lower half of the sealing strip. The upper or lower half can be the upper or lower 50±10% of the height of the sealing strip.

The upper half of the sealing strip can be the half that is designed to face the pane. The lower half of the sealing strip can be the half that is designed to face the frame of a door or window. The frame can be the part of a window or door that is designed to fix a pane and be inserted into a masonry. The frame can be made of plastic or wood.

The sealing strip has a height and a width. The height can be the distance between the highest and lowest position of the sealing strip. The highest position can be in the head area, preferably in a contact shoulder. The lowest position can be in the foot area, preferably in a holding area. The holding area can be an area of the sealing strip that is designed to fix the sealing strip in a frame. A holding area can be designed as a retaining bead or as a holder. The advantage of the holding area is the simple, stable fixing of the sealing strip in the frame and the improved insulating properties of the window or door. The width of a sealing strip can be the distance from one outer edge to the other outer edge of the sealing strip. When determining the distance, the sealing strip is preferably oriented so that the head area is at the top and the foot area is at the bottom.

The head area can have a central web. The central web is preferably designed to face a pane, in particular the lower edge of a pane. The central web can be flat. The advantage of the flat central web is the simple manufacture of the sealing strip. However, the central web can also have one or more openings and/or elevations. In particular, openings can be holes or slots that extend along the longitudinal direction of the sealing strip. The elevations can be formed in such a way that a part of the central web does not lie flat in a plane with the rest of the central web, but protrudes from it. The protrusions can be made from the elastomer composition according to the invention, from a sponge rubber mixture, an elastomer, a silicone or a soft rubber mixture. The advantage of the elevations made from the elastomer composition according to the invention is the simple production by extrusion, calendering or pressing and the low thermal conductivity. The advantage of the elevations made of a sponge rubber mixture, an elastomer, a silicone or a soft rubber mixture is the individual adaptation of the elevations and an individual optimization of the insulating properties at the contact point between the pane and the central web. The openings and/or elevations can have any shape that can extend in a longitudinal direction. In particular, the openings and/or elevations can have a round, elliptical or polygonal shape. The openings and/or elevations can also have the shape of a series of different geometric shapes, in particular a wave shape. The advantage of the openings and/or elevations is that the sealing strip can be compressed more easily in the area of the central web, making it easier to insert the pane. Furthermore, the openings and/or elevations have the advantage that the contact area between the pane and the central web has increased insulating properties and the thermal insulation of the window or door is improved. The central web can be made of the elastomer composition according to the invention. The advantage of the central web made of the elastomer composition according to the invention is the low thermal conductivity and the good insulating properties. The central web can also be made of a conventional sponge rubber or a sponge rubber mixture, an elastomer, a silicone or a soft rubber mixture. The advantage of this central web is that the elasticity in the area of the central web can be individually adapted to the weight of the pane so that optimum thermal insulation can be achieved.

The head area can have a contact shoulder. The contact shoulder can be an elevation which is located laterally next to the central web. A first side of the contact shoulder can be designed to face a pane, in particular a side edge of a pane. A second side of the contact shoulder can be designed to face away from a pane and towards a frame of a window or a door. A contact shoulder can have various geometric shapes such as a circular, semi-circular, elliptical or polygonal shape, in particular a polygonal shape with rounded corners, but can also be flat so that the contact shoulder lies in the same plane as the central web. The advantage of the flat contact shoulder is the simple, cost-effective production of the sealing strip. The advantage of the contact shoulder, which is designed as an elevation, is that the pane can be optimally fixed and the thermal insulation is increased.

Preferably, the contact shoulder can have a shape that essentially corresponds to the shape of a trapezoid. The shape that essentially corresponds to the shape of a trapezoid can be any shape that is similar to a trapezoid, in particular the shape can be a trapezoid with rounded edges. Furthermore, the shape can be designed in such a way that the upper side of the trapezoid-like shape is inclined, i.e. has an angle between 1° and 45°, preferably between 2° and 30° to the horizontal. The advantage of the angle between 1° and 45° is the simplified fixing of the sealing strip in the frame. The advantage of the angle between 2° and 30° to the horizontal is a simplified and improved fixing of the sealing strip in the frame. The contact shoulder can comprise elevations and/or openings or recesses. The openings or recesses can have any geometric shape, in particular a circular, semi-circular or polygonal shape. The advantage of the openings or recesses is a more stable fixation of the sealing strip in the frame. The contact shoulder can be made of the elastomer composition according to the invention, a sponge rubber mixture, an elastomer, a silicone or a soft rubber mixture. The advantage of the contact shoulder made from the elastomer composition according to the invention is its low thermal conductivity. The contact shoulder can consist of one material or a material mixture, or of several different materials, in particular two different materials. The advantage of the contact shoulder made of a sponge rubber mixture, an elastomer, a silicone, a soft rubber mixture or of one or more material mixtures is the possibility of adapting the contact shoulder individually to the shape of different frames and thus enabling good thermal insulation for different frame shapes.

The foot area of the sealing strip can comprise a holding area, which is designed to mechanically fix the sealing strip in a frame of a window or door. In addition to one or more holding areas in the foot area, one or more holding areas can be provided in the head area. Preferably, the holding area can have a shape that enables mechanical fastening of the sealing strip in a frame of a window or door. In particular, the holding area can have retaining beads, thickenings, elevations, hooks and openings. The advantage of the holding area is the stable fixing of the sealing strip in the frame and the increased thermal insulation of the window or door. The foot area of the sealing strip can have one or more holding areas. A holding area can extend over a partial area or over the entire width of the foot area. Several holding areas can have different shapes or the same shape and be made of the same or different materials. A holding area may be made of the elastomer composition according to the invention, a sponge rubber mixture, an elastomer, a silicone or a soft rubber mixture.

The sealing strip can have one or more air ducts. An air duct can be a hollow shape that is located inside the sealing strip and extends in the longitudinal direction. The sealing strip may have none, one or more air ducts. The sealing strip may have 1-10, preferably 1-7 and most preferably 2-7 air ducts. The air ducts can have any geometric shape, which can extend in the longitudinal direction. The air ducts can have a circular, semi-circular, elliptical or polygonal shape, in particular the shape of polygons with rounded corners. The advantage of the air ducts in the sealing strip is the saving of material, the low weight of the sealing strip, the improved thermal insulation properties and the increased elasticity.

The sealing strip according to the invention can consist of 100% of the elastomer composition according to the invention. Partial areas of the sealing strip according to the invention can consist of one or more other materials. Other materials may be prior art materials. Other materials may preferably be sponge rubber, sponge rubber mixtures, soft rubber or soft rubber mixtures. In particular, the partial area can be a partial area of a cross-section of the sealing strip. The partial area can be the head area, a partial area of the head area, the contact shoulder, a partial area of the contact shoulder, the central web, a partial area of the central web, the holding area or a partial area of the holding area. The partial area can be any part or percentage of the sealing strip that is smaller than the entire sealing strip, wherein the entire sealing strip corresponds to 100%.<100% of the sealing strip, preferably <90% of the sealing strip, more preferably <75% of the sealing strip, particularly preferably <50% of the sealing strip can consist of one or more other materials. The advantage of the sealing strip, which consists of <100% of a prior art material, is the thermal conductivity, which is reduced compared to sealing strips consisting entirely of prior art materials. The advantage of the sealing strip, which consists of less than <90% prior art material, is the low thermal conductivity. The advantage of the sealing strip, which consists of less than <75% prior art material, is the low thermal conductivity and the increased rigidity of the sealing strip. The advantage of the sealing strip, which consists of less than <50% prior art material, is the optimum rigidity of the sealing strip and the low thermal conductivity.

### BRIEF DESCRIPTION OF THE DRAWINGS

The advantages and further features of the invention are apparent from the following description of preferred embodiments of the subject-matter of the invention with reference to the accompanying figures. The following description serves only to clarify the invention and should not be understood as limiting the claims to one of the embodiments. It shows

FIG. 1-FIG. 6 are side views of a cross-section of a center seal according to a respective embodiment of the invention, comprising an elastomer composition according to the invention;

FIG. 7-FIG. 11 are side views of a cross-section of a center seal according to a respective embodiment of the invention, comprising an elastomer composition according to the invention and a sponge rubber mixture of the prior art;

FIG. 12-FIG. 15 are side views of a cross-section of a center seal according to a respective embodiment of the invention, comprising an elastomer composition according to the invention and a soft rubber mixture of the prior art;

FIG. 16-FIG. 22 are side views of a cross-section of a side seal according to a respective embodiment of the invention, comprising an elastomer composition according to the invention and a sponge rubber mixture of the prior art; and

FIG. 23-FIG. 31 are side views of a cross-section of an insulating strip according to a respective embodiment of the invention, comprising an elastomer composition according to the invention.

### DETAILED DESCRIPTION

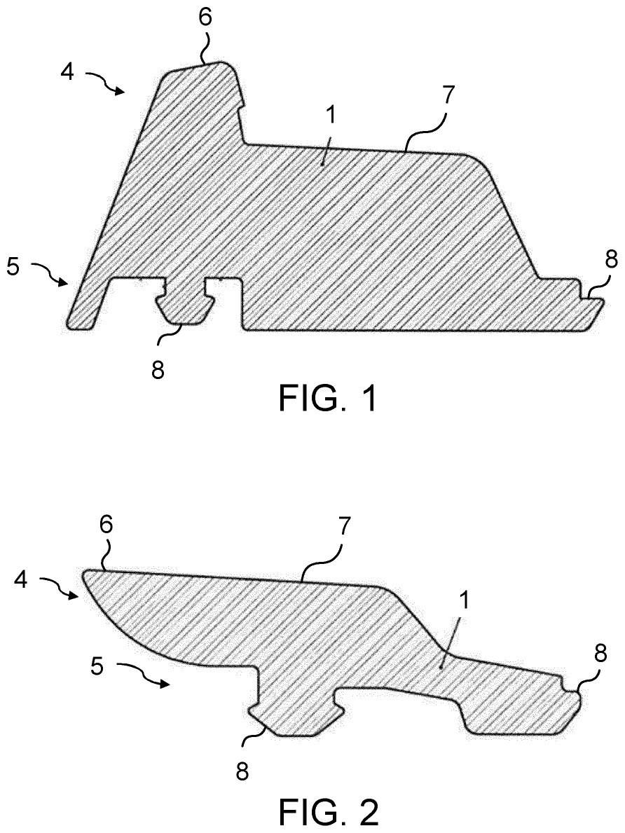

FIG. 1 shows a side view of a cross-section of a center seal according to one embodiment of the invention. The area hatched with oblique lines corresponds to the part of the center seal which consists of the elastomer composition 1 according to the invention. According to the embodiment shown, the sealing strip consists entirely of the elastomer composition 1 according to the invention. The sealing strip has a flat central web 7. The sealing strip also has a contact shoulder 6, which is located next to the central web 7 and has a trapezoidal shape with an inclined upper side. On the side that is designed to face a pane, the contact shoulder has a narrow opening near the central web 7, the shape of which is similar to a rectangle with rounded corners. The outer edges of the sealing strip are arranged at an angle so that the sealing strip becomes wider in the direction of the foot area 5. In the area below the contact shoulder 6, the foot area 5 has a holding area 8, consisting of an opening with a holding nub 8, wherein the holding nub 8 has the shape of a rectangle with a trapezoid on its underside. The foot area 5 also has a further holding area 8 on the opposite side, which comprises a rectangular and a trapezoid-like elevation.

FIG. 2 shows a side view of a cross-section of a center seal according to a further embodiment of the invention. The sealing strip consists entirely of the elastomer composition 1 according to the invention, as shown by the shaded area. The sealing strip has a flat central web 7 and a flat contact shoulder 6. The outer edges of the sealing strip are arranged at an angle, with one side of the sealing strip becoming narrower towards the foot area 5 and the other side becoming wider. A holding nub 8 is located approximately in the middle of the foot area 5. On the side of the sealing strip that becomes wider in the direction of the foot area 5, there is a further holding area 8, which has the approximate shape of an upside-down trapezoid, with the upper, outer corner of the trapezoid having an opening.

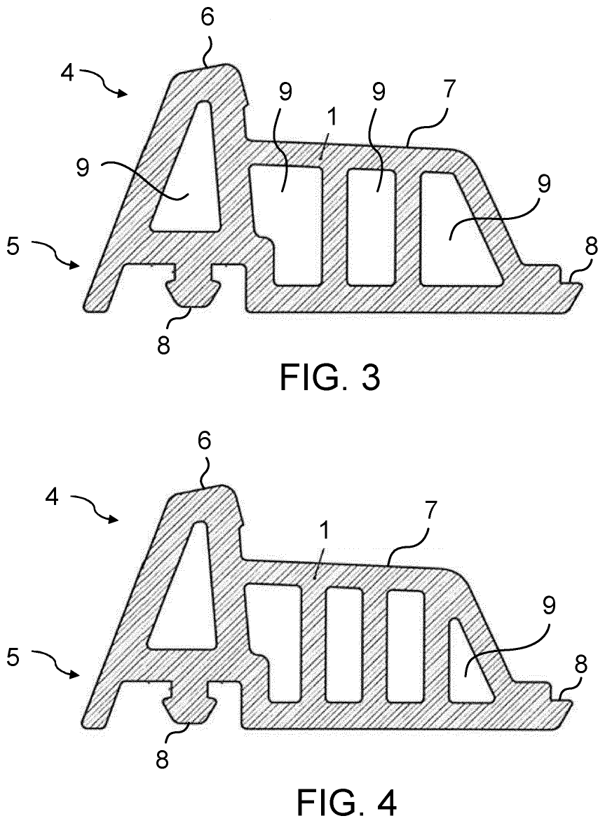

FIG. 3 shows a side view of a cross-section of a center seal according to a further embodiment of the invention. This embodiment is similar to the embodiment shown in FIG. 1. In contrast to the embodiment shown in FIG. 1, this embodiment has four air ducts 9. A first air duct 9 has the shape of a triangle with rounded corners and is located inside the contact shoulder 6 and extends into the foot area 5 below the contact shoulder 6. Next to this air duct 9 and below the central web 7, there are three further air ducts 9, which also extend from the head area 4 of the sealing strip into the foot area 5. The second air duct 9, which is located next to the first air duct 9, has the approximate shape of a rectangle with rounded corners, in which the lower half of the left side edge has been offset inwards, resulting in a geometric shape with six corners, but which does not correspond to a regular hexagon. Next to the second air duct 9 is a third air duct 9, which has the shape of a rectangle with rounded corners. Next to the third air duct 9 is a fourth air duct 9, which has the shape of a trapezoid with rounded corners.

FIG. 4 shows a side view of a cross-section of a center seal according to a further embodiment of the invention. This embodiment is similar to the embodiment shown in FIG. 3. In contrast to the embodiment shown in FIG. 3, this embodiment has four air ducts 9 in the area below the sealing strip, wherein the two central air ducts 9 have the shape of rectangles with rounded corners.

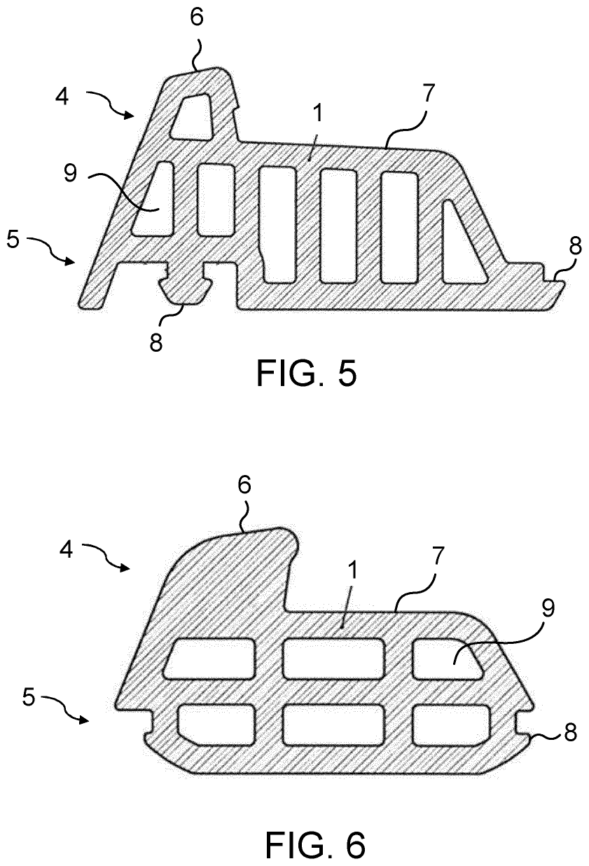

FIG. 5 shows a side view of a cross-section of a center seal according to a further embodiment of the invention. This embodiment is similar to the embodiment shown in FIG. 4. In contrast to the embodiment shown in FIG. 4, this embodiment has an air duct 9 within the contact shoulder 6, which is located exclusively in the head area 4 of the sealing strip, and two further air ducts 9 in the region below the contact shoulder 6, which extend from the lower end of the head area 4 into the foot area 5 of the sealing strip. The air duct 9 in the contact shoulder 6 has the shape of a trapezoid with rounded corners and a sloping top. The first air duct 9, which is located below the contact shoulder 6 and closest to the outer edge of the sealing strip, has the shape of a trapezoid with rounded corners. The second air duct 9, which is located next to the first air duct 9 and below the contact shoulder 6, has the shape of a rectangle with rounded corners.

FIG. 6 shows a side view of a cross-section of a center seal according to a further embodiment of the invention. The sealing strip has a contact shoulder 6 without an air duct 9. Below the contact shoulder 6 there are two air ducts 9, which are arranged one below the other. The upper air duct 9 has the shape of a trapezoid with rounded corners. The air duct 9 below has a shape similar to a rectangle with rounded corners, in which the lower left corner has been cut off, resulting in a pentagonal shape that is not a regular pentagon. There are four air ducts 9 below the central web 7, with two air ducts 9 arranged one above the other. The two air ducts 9, which are located below a central web 7 and are arranged centrally in the sealing strip, have the shape of rectangles with rounded corners. The two other air ducts 9 are located below the central web 7 on the side of the sealing strip opposite the contact shoulder 6. The upper air duct 9 has the shape of a trapezoid with rounded corners. The lower air duct 9 has a shape that resembles a rectangle with rounded corners, in which the lower right corner has been cut off, resulting in a pentagonal shape that is not a regular pentagon. There is a holding nub 8 in the foot area 5, the shape of which resembles a trapezoid with rounded corners and which extends over almost the entire width of the foot area 5 or the sealing strip. The inner part of the holding nub 8 includes the three lower air ducts 9, wherein the three lower air ducts 9 also extend into the area above the holding nub 8.

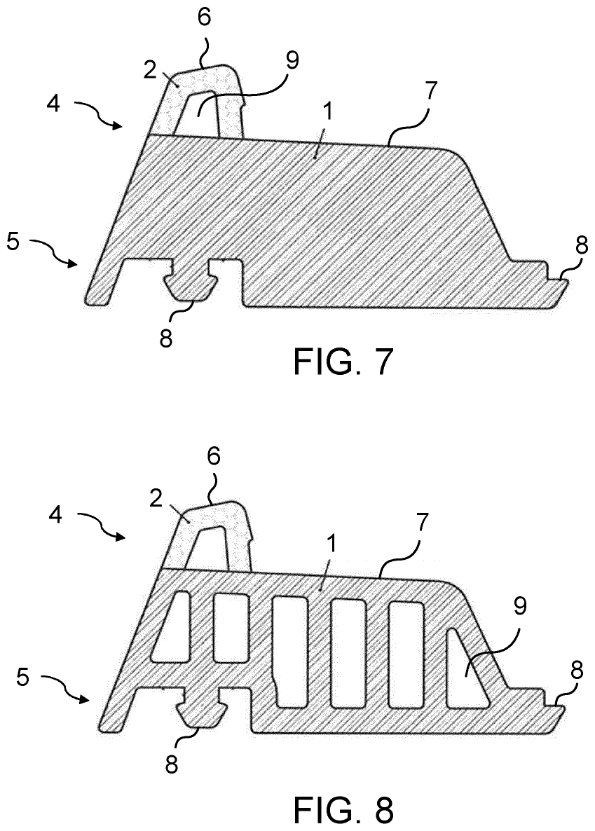

FIG. 7 shows a side view of a cross-section of a center seal according to a further embodiment of the invention, which is similar to the embodiment shown in FIG. 1. In contrast to the embodiment shown in FIG. 1, the contact shoulder 6 of this embodiment is made of a sponge rubber 2 or a sponge rubber mixture 2. The area hatched with a honeycomb pattern corresponds to the part of the center seal that is made of the sponge rubber 2 or a sponge rubber mixture 2. The contact shoulder 6 also has an air duct 9. The air duct 9 is located inside the contact shoulder 6 in the head area 4 of the sealing strip and has the shape of a trapezoid with rounded corners and a sloping top. The rest of the sealing strip is made of the elastomer composition 1 according to the invention.

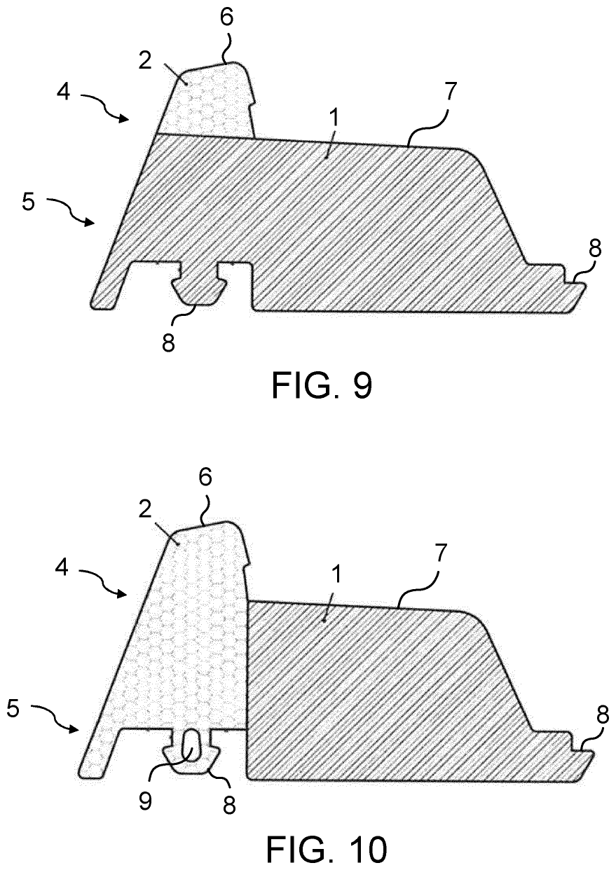

FIG. 8 shows a side view of a cross-section of a center seal according to a further embodiment of the invention. The embodiment shown is similar to the embodiment shown in FIG. 7. In contrast to the embodiment shown in FIG. 7, this embodiment has two air ducts 9 in the region below the contact shoulder 6 and four air ducts 9 in the region below the central web 7. The shape and position of the air ducts 9 of this embodiment correspond to the shape and position of the air ducts 9 of the embodiment shown in FIG. 5. In contrast to the embodiment shown in FIG. 5, the contact shoulder 6 of this embodiment is made of a sponge rubber 2 or a sponge rubber mixture 2. The area hatched with a honeycomb pattern corresponds to the part of the center seal that is made of a sponge rubber 2 or a sponge rubber mixture 2.

FIG. 9 shows a side view of a cross-section of a center seal according to a further embodiment of the invention. The sealing strip is similar to the embodiments shown in FIG. 1 or FIG. 7. In contrast to the embodiment shown in FIG. 1, the contact shoulder 6 of this embodiment is made of a sponge rubber 2 or a sponge rubber mixture 2. In contrast to the embodiment shown in FIG. 7, the contact shoulder 6 of this embodiment does not have an air duct 9. The sealing strip has no air ducts 9.

FIG. 10 shows a side view of a cross-section of a center seal according to a further embodiment of the invention. This embodiment is similar to the embodiment shown in FIG. 9. In contrast to the embodiment shown in FIG. 9, however, in this embodiment not only the contact shoulder 6 is made of a sponge rubber 2 or a sponge rubber mixture 2, but also the area of the sealing strip, which is located below the contact shoulder 6 and extends into the foot area 5. The sealing strip has exactly one air duct 9. The one air duct 9 has an elliptical shape, wherein the ellipse is arranged in such a way that it extends in a vertical direction. The one air duct 9 is located in the foot area 5 in a holding nub 8, which is arranged in the area of the foot area 5, which is located below the contact shoulder 6.

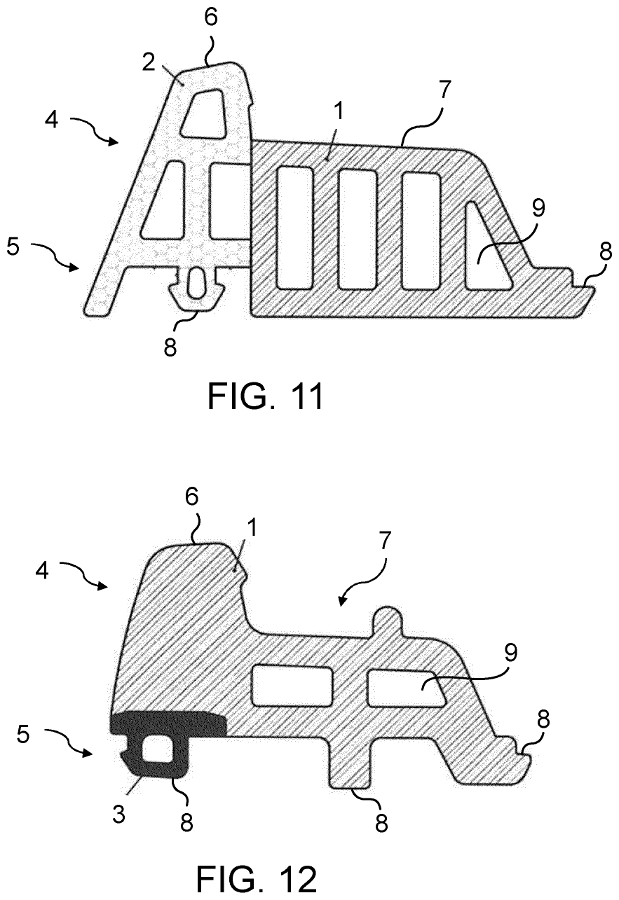

FIG. 11 shows a side view of a cross-section of a center seal according to a further embodiment of the invention. This embodiment is similar to the embodiment shown in FIG. 10. In contrast to the embodiment shown in FIG. 10, this embodiment has, in addition to the one air duct 9 in the holding nub 8, further, additional air ducts 9 in the contact shoulder 6, in the region below the contact shoulder 6 and in the region below the central web 7, wherein the shape and position of the additional air ducts 9 corresponds to the shape and position of the air ducts 9 of the embodiments shown in FIG. 5 and FIG. 8.

FIG. 12 shows a side view of a cross-section of a center seal according to a further embodiment of the invention. The sealing strip has a contact shoulder 6, which does not have an air duct 9. The sealing strip has a central web 7, which has an almost semi-circular elevation. In the area below the central web 7 there are two air ducts 9, which are arranged next to each other. The air duct 9, which is located closer to the contact shoulder 6, has the shape of a rectangle with rounded corners, whereas the other air duct 9 has the shape of a trapezoid with rounded corners. In the foot area 5, in the area below the contact shoulder 6, there is a holding nub 8, which is made of a soft rubber 3 or a soft rubber mixture 3. The black-filled area of the figure corresponds to the part of the center seal that is made of the sponge rubber 2 or a sponge rubber mixture 2. The holding nub 8 has an air duct 9, the shape of which corresponds to a rectangle with rounded corners, wherein the upper corners are more rounded than the lower corners. A further holding nub 8 without an air duct 9 is located in the center of the foot area 5 of the sealing strip, wherein this holding nub 8 consists of the elastomer composition 1 according to the invention and has the shape of a rectangle with rounded corners. In the foot area 5, on the side opposite the holding nub 8 made of soft rubber 3 or soft rubber mixture 3, there is a further holding area 8 without an air duct 9. This holding area 8 has a rectangular and trapezoidal elevation.

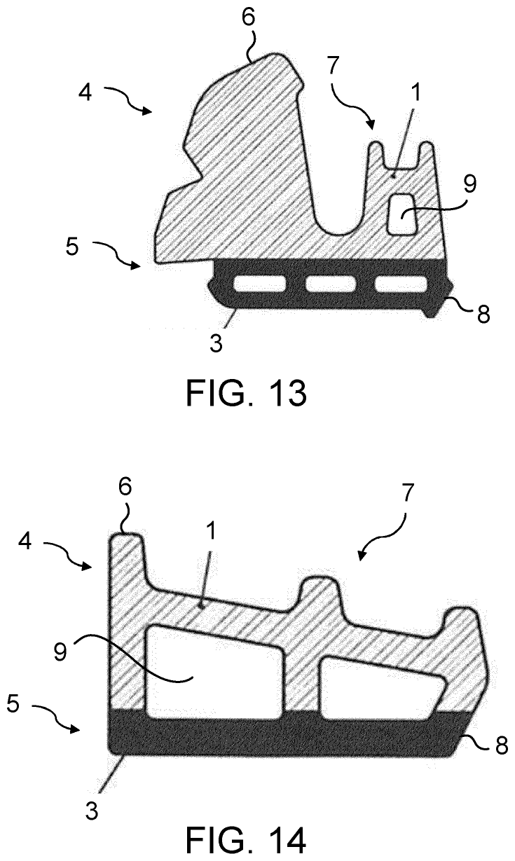

FIG. 13 shows a side view of a cross-section of a center seal according to a further embodiment of the invention. The sealing strip has a contact shoulder 6 and a central web 7. The sealing strip has an opening in the form of a triangle in the area below the contact shoulder 6 on the side which is designed to face away from the pane and towards a frame. The contact shoulder 6 has an opening on the side that is designed to face a pane. This opening extends into the area below the central web 7. The opening extends from the head area 4 to approximately the middle of the foot area 5 and is located centrally in the sealing strip. At the lower end, the opening has a semi-circular shape. The central web 7 also has two elongated elevations with a semi-circular upper side. Below the two elevations of the central web 7 is an air duct 9, which has the shape of a trapezoid with rounded corners. In the foot area 5 there is a holding area 8, which is made of a soft rubber 3 or a soft rubber mixture 3 and has three air ducts 9 of approximately the same size, which are shaped like rectangles with rounded corners. The holding area 8 extends over almost the entire width of the foot area 5 or the sealing strip.

FIG. 14 shows a side view of a cross-section of a center seal according to a further embodiment of the invention. The sealing strip has a contact shoulder 6 in the form of a rectangle with rounded corners and a central web 7. The central web 7 has two elevations which are in the shape of trapezoids with rounded corners. One elevation is located in the middle of the central web 7. The other elevation is located on the edge of the central web 7, on the side opposite the contact shoulder 6. In the foot area 5 there is a holding area 8 with a flat underside. The holding area 8 is made of soft rubber 3 or a soft rubber mixture 3 and extends over the entire width of the foot area 5 or the sealing strip. Below the central web 7 are two air ducts 9, which have the shape of trapezoids with rounded corners and a sloping top. The two air ducts 9 extend into the foot area 5 and into the holding area 8.

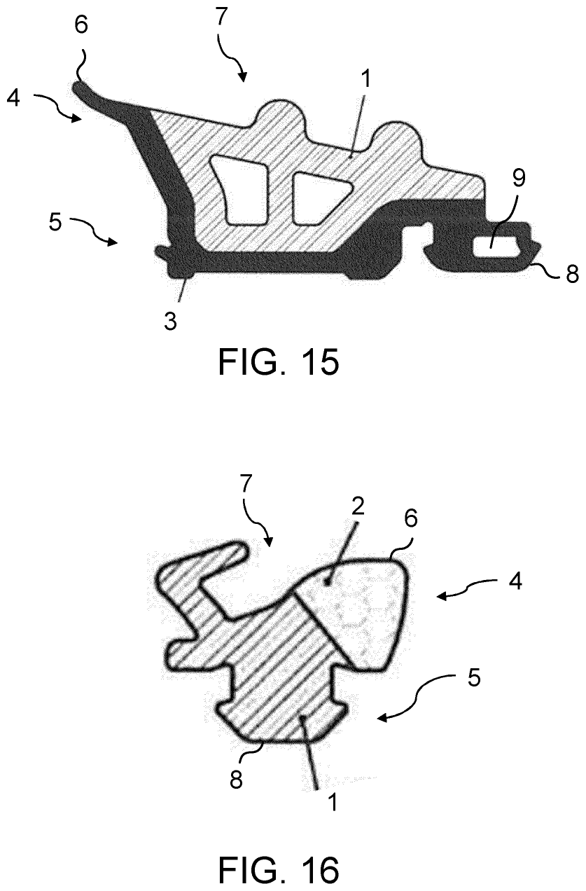

FIG. 15 shows a side view of a cross-section of a center seal according to a further embodiment of the invention. The sealing strip has a central web 7. The central web 7 has two semicircular elevations. A first semicircular elevation is located centrally on the central web 7. The second semicircular elevation is located between the first elevation and the outer edge of the sealing strip, which is opposite the contact shoulder 6. The sealing strip has a contact shoulder 6, which has a curvature and merges flat, at an angle of 180°, into the central web 7. The contact shoulder 6 protrudes laterally beyond the rest of the sealing strip. There are two air ducts 9 in the area below the central web 7. The first air duct 9, which is located closer to the side of the contact shoulder 6, has the shape of a rectangle with rounded corners, wherein the side edge facing the outer edge of the sealing strip has a concave curvature. A second air duct 9 is located next to the first air duct 9. The second air duct 9 has the shape of a trapezoid with rounded corners. The contact shoulder 6 is made of soft rubber 3 or a soft rubber mixture 3. An outer border of the outer edge of the sealing strip, which extends from the contact shoulder 6 into the foot area 5 and over the entire width of the foot area 5, is made of soft rubber 3 or a soft rubber mixture 3. The foot area 5 has a holding area 8, which is made of soft rubber 3 or a soft rubber mixture 3 and extends over the entire width of the foot area 5. The holding area 8 has a semi-circular elevation on the outer edge, which is on the same side as the contact shoulder 6. Next to this elevation, on the underside of the sealing strip, there is another elevation in the shape of a rectangle with rounded corners. In the foot area 5 below the second elevation of the central web 7, there is an elevation in the shape of a trapezoid. Directly next to this elevation, on the side that faces away from the contact shoulder 6, there is an opening. Next to this opening is a holding nub 8, which is made of soft rubber 3 or a soft rubber mixture 3. The holding nub 8 has an air duct 9, which has the shape of a rectangle with rounded corners, wherein the side edge of the rectangle, which faces the outer edge of the sealing strip, has a curvature.

FIG. 16 shows a side view of a cross-section of a side seal according to a further embodiment of the invention. The sealing strip has a contact shoulder 6, which is made of a sponge rubber 2 or a sponge rubber mixture 2, wherein the area of the sealing strip below the contact shoulder 6 also is made of sponge rubber 2 or a sponge rubber mixture 2. The sealing strip has a central web 7, which has an opening. The central web 7 also has an elevation. The elevation is shaped like a hook or an upside-down letter “L”. A holding nub 8 is located in the middle of the foot area 5 of the sealing strip. The side seal has no air ducts 9.

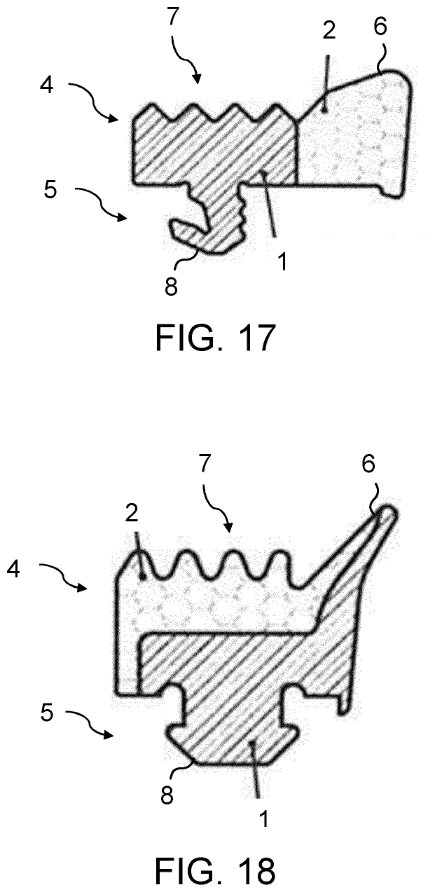

FIG. 17 shows a side view of a cross-section of a side seal according to a further embodiment of the invention. The sealing strip has a contact shoulder 6 and an area below the contact shoulder, which consist of sponge rubber 2 or a sponge rubber mixture 2. The side seal has a central web 7. The central web 7 has four elevations in the form of triangles. In the foot area 5, centrally below the central web 7, there is a holding area 8, which has the shape of a hook with a wave-shaped surface, wherein the hook is aligned so that it points away from the contact shoulder 6.

FIG. 18 shows a side view of a cross-section of a side seal according to a further embodiment of the invention. The sealing strip has a central web 7. The central web 7 has wave-shaped elevations. One of the wave-shaped elevations extends in such a way that it forms an upper part of the contact shoulder 6. The central web 7, the area below the central web 7 in the head area 4 of the sealing strip, the wave-shaped elevations of the central web 7 and the upper part of the contact shoulder 6, as well as the outer edge of the sealing strip, which faces away from the contact shoulder 6, are made of sponge rubber 2 or a sponge rubber mixture 2. The lower part of the contact shoulder 6 and the foot area 5 are made of the elastomer composition 1 according to the invention. The foot area 5 has a holding nub 8 in the middle. On the outer edge of the sealing strip, on the side of which the contact shoulder 6 is also located, there is a narrow elevation at the bottom, which extends in a vertical direction.

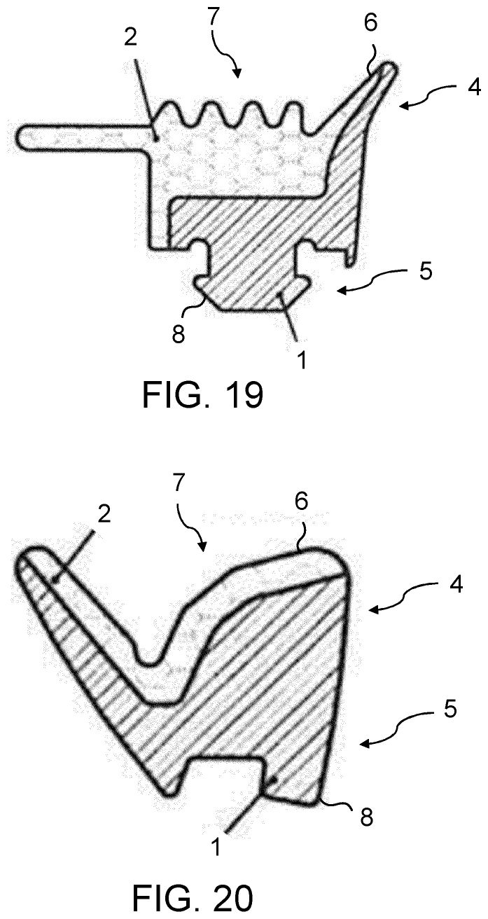

FIG. 19 shows a side view of a cross-section of a side seal according to a further embodiment of the invention. The embodiment is similar to the embodiment shown in FIG. 18. In contrast to the embodiment shown in FIG. 18, this embodiment has an elevation made of sponge rubber 2 or a sponge rubber mixture 2 on the outer edge facing away from the contact shoulder 6. The elevation has an elongated shape with a semicircular tip and extends in a horizontal direction so that the elevation protrudes laterally beyond the sealing strip.

FIG. 20 shows a side view of a cross-section of a side seal according to a further embodiment of the invention. The sealing strip has a central web 7. The central web 7 has an opening in the form of a triangle, which extends over the entire width of the central web 7. The opening extends into the lower head area 4 and almost into the foot area 5 of the sealing strip. The contact shoulder 6, the central web 7 and the outer edge of the opening of the central web 7 are made of sponge rubber 2 or a sponge rubber mixture 2. The area below the areas made of sponge rubber 2 or sponge rubber mixture 2 is made of the elastomer composition 1 according to the invention. The foot area 5 has a holding area 8. In the foot area 5 below the contact shoulder 6, there is a holding nub 8 in the form of a trapezoid with rounded corners, whereas on the opposite side there is a holding nub 8 in the form of a rounded triangle.

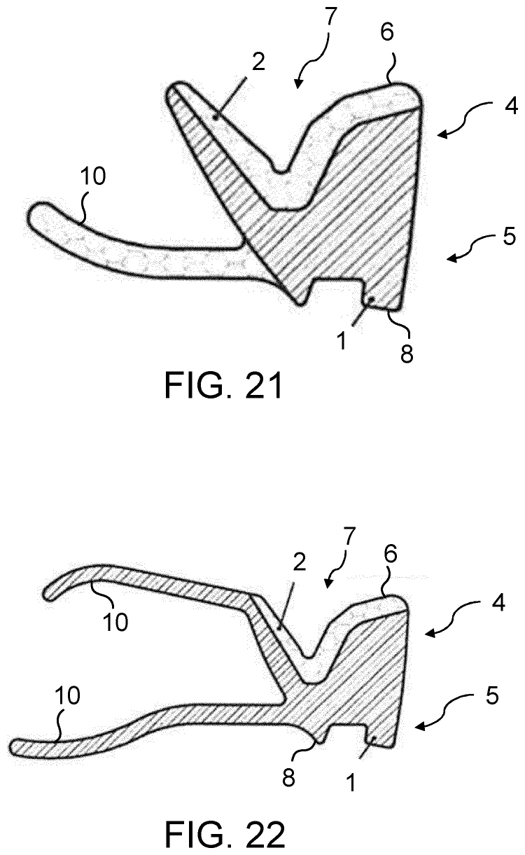

FIG. 21 shows a side view of a cross-section of a side seal according to a further embodiment of the invention. The embodiment shown is similar to the embodiment shown in FIG. 20. In contrast to the embodiment shown in FIG. 20, a holder 10, which is made of sponge rubber 2 or a sponge rubber mixture 2, is attached in the foot area 5 of this embodiment. The holder 10 is attached to the outer edge of the sealing strip, which faces away from the contact shoulder 6, and has an elongated shape with a semicircular tip, which protrudes laterally beyond the rest of the sealing strip.

FIG. 22 shows a side view of a cross-section of a side seal according to a further embodiment of the invention. The embodiment shown is similar to the embodiment shown in FIG. 20. In contrast to the embodiment shown in FIG. 20, this embodiment has two further holders 10, which consist of the elastomer composition 1 according to the invention. Both holders 10 are attached to the outer edge of the sealing strip, which faces away from the contact shoulder 6, wherein one holder 10 is attached in the head area 4 and the other in the foot area 5. Both holders 10 have an elongated shape with a semicircular tip, which protrudes laterally beyond the rest of the sealing strip.

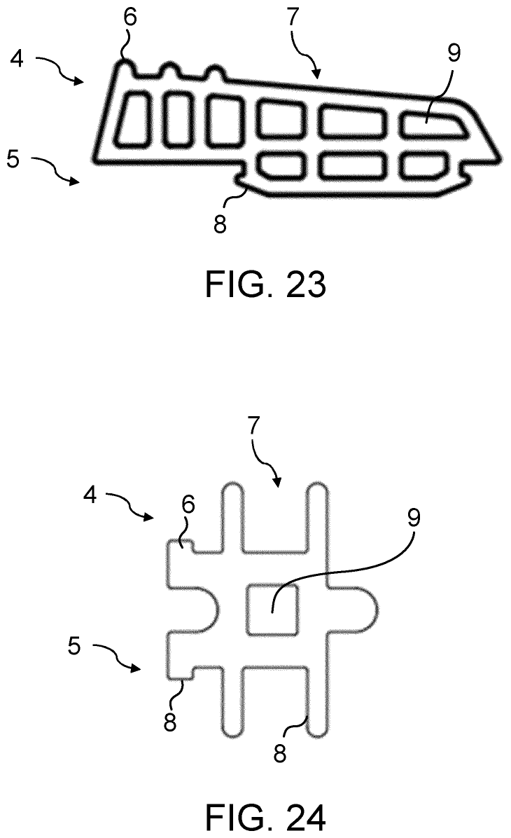

FIG. 23 shows a side view of a cross-section of an insulating strip according to one embodiment of the invention. The sealing strip has a predominantly flat central web 7 with two semicircular elevations. The sealing strip has a contact shoulder 6, which is located next to the central web 7 and has a semicircular shape. The outer edges of the sealing strip are arranged at an angle so that the sealing strip becomes wider in the direction of the foot area 5. The foot area 5 has a holding area 8 in the area below the central web 7. The holding area 8 is designed as a holding nub, which has the shape of a rectangle with a trapezoid on the underside. The sealing strip has nine air ducts 9. A first air duct 9 is located below the contact shoulder 6 and has the shape of a trapezoid with rounded corners. Next to the first air duct 9 and below the central web 7 is a second air duct 9, which has the shape of a rectangle with rounded corners. A third, fourth and fifth air duct 9 are located next to the second air duct 9 and below the central web 7. The third, fourth and fifth air ducts 9 have the shape of a rectangle with a slanted top or slanted top edge and rounded corners. Next to the fifth air duct 9 and below the central web 7 is a sixth air duct 9, which has the shape of a trapezoid with rounded corners. A seventh, an eighth and a ninth air duct 9 are located in the foot area 5 of the sealing strip and extend into the holding area 8. The seventh air duct 9 is located below the fourth air duct 9, the eighth air duct 9 is located below the fifth air duct 9 and the ninth air duct 9 is located below the sixth air duct 9. The seventh and ninth air ducts 9 have a shape that resembles a rectangle with rounded corners, in which the lower, left or right corner has been cut off, resulting in a pentagonal shape that is not a regular pentagon. The eighth air duct 9, which is located between the seventh and ninth air ducts 9, has the shape of a rectangle with rounded corners.

FIG. 24 shows a side view of a cross-section of an insulating strip according to a further embodiment of the invention. The sealing strip has a contact shoulder 6 in the form of a rectangle. The central web 7 has two elevations which extend perpendicular to the central web 7. A rectangular air duct 9 is located below the central web 7. Below the contact shoulder 6, there is an opening in the shape of a half ellipse. On the opposite side of the sealing strip there is an elevation in the shape of a half ellipse, which is congruent with the shape of the opening. In the foot area 5 of the sealing strip, below the contact shoulder 6, there is a holding area 8 in the shape of a rectangle, wherein the shape of the holding area 8 is congruent with the shape of the contact shoulder 6. In the foot area 5 below the elevations of the central web 7 there are two holding areas 8, which extend vertically from the foot area 5 and whose shape is congruent with the shape of the elevations of the central web 7. The shape of the cross-section of the sealing strip is mirror-symmetrical to a horizontal mirror axis.

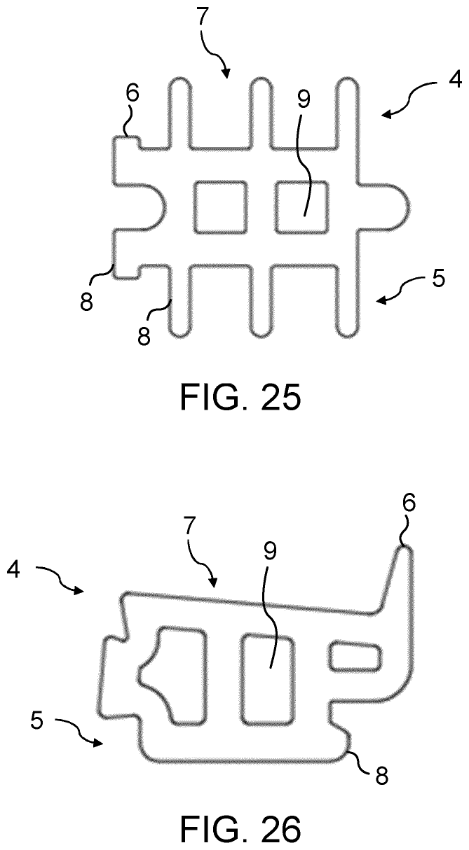

FIG. 25 shows a side view of a cross-section of an insulating strip according to one embodiment of the invention. The embodiment shown is similar to the embodiment shown in FIG. 24. In contrast to the embodiment shown in FIG. 24, this embodiment has three elevations in the head area 4 in the region of the central web 7 and three holding areas 8 in the foot area 5, which extend vertically and whose shape is congruent with the shape of the elevations of the central web 7. The sealing strip has two rectangular air ducts 9.

FIG. 26 shows a side view of a cross-section of an insulating strip according to a further embodiment of the invention. The sealing strip has a flat central web 7. The contact shoulder 6 has the shape of a triangle with rounded corners. The outer edge of the sealing strip opposite the contact shoulder 6 is arranged at an angle, so that the sealing strip becomes narrower in the direction of the foot area 5. The outer edge of the sealing strip opposite the contact shoulder 6 has an elevation in the form of a trapezoid with rounded corners. In the foot area 5, the sealing strip has a holding area 8, which extends over almost the entire width of the foot area 5 or the sealing strip. The sealing strip has three air ducts 9 below the central web 7, which are arranged next to each other. The first air duct 9, which is located near the contact shoulder, and the second air duct, which forms the central air duct, have the shape of a rectangle with a slanted top and rounded corners. The third air duct 9 is located on the side of the sealing strip opposite the contact shoulder. The third air duct has the shape of a rectangle with rounded corners, wherein the two corners, which are located near the outer edge of the sealing strip, each have an opening in the form of a quarter circle.

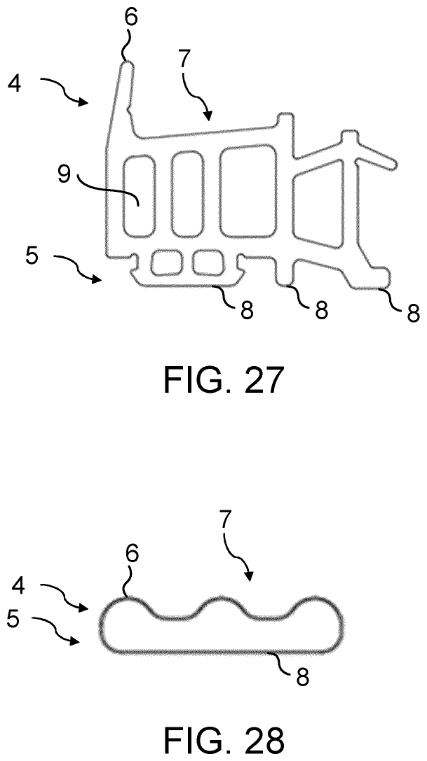

FIG. 27 shows a side view of a cross-section of an insulating strip according to one embodiment of the invention. The sealing strip has a predominantly flat central web 7 with two elevations in the form of rectangles with rounded corners. The central web 7 has an opening in the form of a triangle or a half trapezoid with rounded corners. The sealing strip has a narrow contact shoulder 6 with a rounded top, which extends almost vertically or at a slight angle from the central web 7. The outer edge of the sealing strip facing away from the contact shoulder has an elevation that extends at an angle from the outer edge of the sealing strip. A first, a second, a third and a fourth air duct 9 are arranged below the central web 7, with the air ducts 9 extending from the head area 4 of the sealing strip into the foot area of the sealing strip. The first air duct 9, which is located below the contact shoulder, and the second air duct 9, which is located next to the first air duct 9, have the shape of a rectangle with rounded corners. The third air duct 9, which is located next to the second air duct 9, has the shape of a rectangle with a slanted top and rounded corners. The fourth air duct 9, which is located next to the third air duct 9, has the shape of a trapezoid with rounded corners. The foot area 5 of the sealing strip has a holding area 8 in the form of a holding nub, which has the shape of a rectangle with a trapezoid on the underside. Two air ducts 9 are arranged next to each other within this holding nub, which have the shape of rectangles with rounded corners. The foot area 5 also has a further holding area 8 on the opposite side, which comprises a rectangular elevation. A further holding area 8 is arranged between the aforementioned holding areas 8, which has the shape of a rounded rectangle.

FIG. 28 shows a side view of a cross-section of an insulating strip according to one embodiment of the invention. The sealing strip has a semicircular contact shoulder 6. The sealing strip has a central web 7 with two semicircular projections. The holding area 8 in the foot area 5 of the sealing strip is flat. The sealing strip has no air ducts 9.

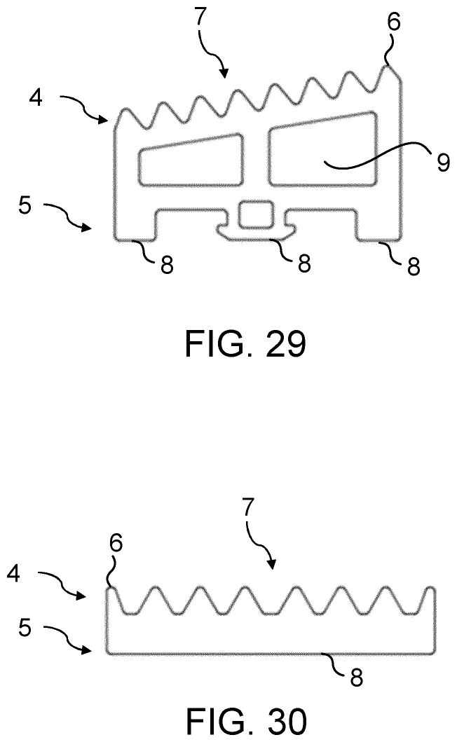

FIG. 29 shows a side view of a cross-section of an insulating strip according to one embodiment of the invention. The sealing strip has a central web 7 with elevations arranged side by side in the form of triangles with rounded corners. The sealing strip has a contact shoulder 6, which does not differ significantly from the elevations of the central web 7. Below the central web 7 there are two air ducts 9 arranged next to each other. The air ducts have the shape of rectangles with a slanted top and rounded corners, which extend from the head area 4 to the foot area 5 of the sealing strip. There are two rectangular holding areas 8 in the foot area 5, wherein one of the holding areas 8 is arranged on an outer edge of the sealing strip. A central holding area 8 is located centrally between these two holding areas 8 arranged on the outer edges. The central holding area 8 is designed as a holding nub, which has the shape of a rectangle with a trapezoid on the underside. In the foot area 5, below the two air ducts 9 arranged next to each other, there is another air duct 9 arranged in the middle, which has the shape of a rectangle with rounded corners and which extends into the central holding area 8.

FIG. 30 shows a side view of a cross-section of an insulating strip according to a further embodiment of the invention. The sealing strip has a central web 7 with elevations arranged next to one another in the form of triangles with rounded corners. At the outer edges of the sealing strip, the central web 7 has a narrower elevation or a narrow contact shoulder 6 compared to the other elevations. The holding area 8 in the foot area 5 of the sealing strip is flat. The outer edges of the sealing strip run perpendicular to the holding area.

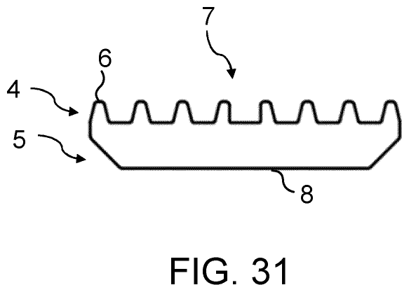

FIG. 31 shows a side view of a cross-section of an insulating strip according to one embodiment of the invention. The sealing strip has a central web 7 with elevations in the form of trapezoids with rounded corners. The sealing strip has a contact shoulder 6, which does not differ significantly from the elevations of the central web 7. In the foot area 5, the outer edges of the sealing strip run at an angle so that the sealing strip becomes narrower in the direction of the holding area 8. The holding area 8 is flat.

The individual features and embodiments mentioned above can be combined with each other and the advantages assigned to the individual features also apply to a combination of these features.

The invention also relates to a use of the sealing strip according to the invention for thermal insulation, preferably for thermal insulation in the construction sector, in particular as a center seal, side seal and/or insulating strip, for example in window frames or door frames. The sealing strip can be used for the thermal insulation of windows and doors, in particular building windows and building doors. The sealing strips, in particular the insulating strips, can be individually adapted to the respective profiles or profile systems, in particular to aluminum window systems and/or aluminum door systems.

All the advantages and features of the sealing strip according to the invention can be transferred analogously to the use of the sealing strip, and vice versa.

It is understood that the above-mentioned features and the features to be explained below can be used not only in the combinations indicated, but also in other combinations or on their own, without going beyond the scope of the present invention. The aforementioned advantages of features or of combinations of several features are merely exemplary and can take effect alternatively or cumulatively. The combination of features of different embodiments of the invention or of features of different patent claims is possible in deviation from the selected references of the patent claims.

The following examples serve to further explain the invention without limiting the invention thereto.

### EXAMPLES

### Example 1

According to a first embodiment example, the material mixture has the following composition:
100 phr EPDM
132 phr Carbon black N772
20 phr chalk
93.5 phr plasticizer
7 phr Vaseline
3 phr Aflux 42
5 phr Faktis F10
8 phr Calcium oxide
1 phr stearic acid
5 phr Zinc oxide
0.5 phr MBT
2 phr TMTD
1.5 phr sulphur
35 phr Expancel 930 DU 120.

The above-mentioned material mixture is treated in an ultra-high frequency (UHF) system with ultra-high frequency microwaves and hot air at a temperature of 200-270° C. Vulcanization of the material mixture results in a material consisting of an elastomer composition. The sealing strip, which consists of the material, has a density of 0.178 g/cm³ and a thermal conductivity λ=0.044 W/(m·K). According to ISO 3386, the material produced according to the invention has a compression hardness of 410 to 490 kPa, in particular 462.0 kPa, at a compression of 25%, 790 kPa to 870 kPa, in particular 836.8 kPa at a compression of 40% and 1220 kPa to 1320 kPa, in particular 1284.0 kPa, at a compression of 50%. According to ISO 8 15, the material has a compression set of 50% at a compression of 25% at 70° C. for 24 hours, a compression set of 33% at a compression of 25% at 23° C. for 24 hours and a compression set of 60% at a compression of 25% for 24 hours at −10° C.

### Example 2

According to a second embodiment example, 20 phr Expancel 930 DU 120 is used in the above-mentioned material mixture. The sealing strip, consisting of the material from the elastomer composition, has a density of 0.252 g/cm³ and a thermal conductivity λ=0.056 W/(m·K). According to ISO 3386, the material obtained by vulcanization of the material mixture has a compression hardness of 850 kPa, in particular 892.0 kPa, at a compression of 25%, 1580 kPa to 1660 kPa, in particular 1623.0 kPa, at a compression of 50% and 2490 kPa to 2560 kPa, in particular 2535.0 kPa, at a compression of 50%. According to ISO 8 15, the material has a compression set of 52% at a compression of 25% for 24 hours at 70° C., a compression set of 28% at a compression of 25% for 24 hours at 23° C. and a compression set of 55% at a compression of 25% for 24 hours at −10° C.

### Examples 3, 4 and 5

In examples 3-5, the composition of example 1 was selected, wherein the proportion of Expancel was varied, and a chemical blowing agent (OBSH) was also used in these examples. The compositions are as follows:
100 phr EPDM
132 phr Carbon black N772
20 phr chalk (light-colored filler)
93.5 phr oil (plasticizer)
7 phr Vaseline (processing aid)
3 phr Aflux 42 (fatty alcohol+fatty acid ester processing aid)
5 phr Faktis F10 (processing aid)
8 phr Calcium oxide (drying agent)
1 phr stearic acid (vulcanization system (activator) and processing aid)
5 phr Zinc oxide (vulcanization system (activator)).
0.5 phr MBT (vulcanization system (accelerator))
2 phr TMTD (vulcanization system (accelerator))
1.5 phr sulphur (vulcanization system (vulcanizing agent))

### Variable for Examples 3-5

Example 3: 20 phr Expancel 930 DU 120 (expandable microspheres)+7 phr OBSH (chemical blowing agent)
Example 4: 30 phr Expancel 930 DU 120 (expandable microspheres)+7 phr OBSH (chemical blowing agent)
Example 5: 40 phr Expancel 930 DU 120 (expandable microspheres)+7 phr OBSH (chemical blowing agent)

The conversions were carried out as described in example 1 and the vulcanization with hot air at 200° C. The following densities of the sealing strips produced were obtained:
Example 3:0.24 g/cm³
Example 4:0.19 g/cm³
Example 5:0.12 g/cm³

### LIST OF REFERENCE SIGNS

1 Elastomer composition
2 Sponge rubber or sponge rubber mixture
3 Soft rubber or soft rubber mixture
4 Head area
5 Foot area
6 Contact shoulder
7 Central web
8 Holding area
9 Air duct
10 Holder

1.-16. (canceled)

17. A sealing strip for windows and doors of an elastomer composition, comprising:
100 phr elastomer; and
20-45 phr expanded microspheres;
wherein an average diameter of the expanded microspheres is 10-200 μm and the elastomer composition has a density of 0.10-0.30 g/cm³.

18. The sealing strip according to claim 17, wherein the elastomer composition has a density of 0.12-0.28 g/cm³.

19. The sealing strip according to claim 17, wherein the elastomer composition comprises 25-40 phr of expanded microspheres.

20. The sealing strip according to claim 17, wherein the elastomer composition further comprises:
10-150 phr plasticizer;
20-400 phr filler;
0-100 phr chemical blowing agent;
1-50 phr excipient; and
0-30 phr drying agent.

21. The sealing strip according to claim 17, wherein the elastomer composition further comprises:
1-15 phr chemical blowing agent.

22. The sealing strip according to claim 17, wherein the average diameter of the expanded microspheres is 40-150 μm.

23. The sealing strip according to claim 17, wherein the elastomer is an EPDM.

24. The sealing strip according to claim 17, wherein the entire sealing strip consists of the elastomer composition or the sealing strip consists of a first and a second partial area, wherein the first partial area consists of the composition and the second partial area consists of sponge rubber or a sponge rubber mixture.

25. The sealing strip according to claim 17, wherein a thermal conductivity of the elastomer composition is λ<0.057 W/(m K).

26. The sealing strip according to claim 17, wherein the elastomer composition has a compression hardness of at least 100 kPa at a compression of 25%, and/or a compression hardness of at least 200 kPa at a compression of 40% and/or a compression hardness of at least 300 kPa at a compression of 50%.

27. The sealing strip according to claim 17, wherein the elastomer composition (1) has a compression set of less than or equal to 70% at a compression of 25% for 24 hours at 70° C. and/or a compression set of less than or equal to 50% at a compression of 25% for 24 hours at 23° C. and/or a compression set of less than or equal to 80% at a compression of 25% for 24 hours at −10° C.

28. The sealing strip according to claim 17, further comprising:
a head area and a foot area;
wherein the head area comprises a central web which is designed to face a pane;
wherein the central web comprises a contact shoulder, wherein one side of the contact shoulder is adapted to face a pane and the other side of the contact shoulder is adapted to face a frame; and
wherein the foot area comprises at least one holding area, which is designed to fix the sealing strip in the frame.

29. The sealing strip according to claim 28, wherein the sealing strip comprises at least one air duct, wherein at least one air duct is located in the region below the central web.

30. A sealing strip according to claim 29, wherein at least one air duct is located inside the contact shoulder and/or at least one air duct is located below the contact shoulder.

31. A method of making a sealing strip according to claim 17, comprising the steps of heating a material mixture comprising 100 phr of elastomer and 20-45 phr of expandable microspheres to a temperature of 75-300° C. and forming a sealing strip.

32. A method of use of a sealing strip according to claim 17, for thermal insulation in the construction sector.
